(19) United States
(12) Patent Application Publication
(10) Pub. No.: US 2017/0361226 A1
(43) Pub. Date: Dec. 21, 2017

(54) PROFILE-BASED, COMPUTING PLATFORM FOR OPERATING SPATIALLY DIVERSE, ASYNCHRONOUS COMPETITIONS

(71) Applicant: Premier Timed Events LLC, College Station, TX (US)

(72) Inventor: Casey Mahoney, College Station, TX (US)

(21) Appl. No.: 15/254,767

(22) Filed: Sep. 1, 2016

Related U.S. Application Data
(60) Provisional application No. 62/350,659, filed on Jun. 15, 2016.

(51) Int. Cl. A63F 13/30; A63F 13/25; A63F 13/213

(52) U.S. Cl. CPC A63F 13/30; A63F 13/213; A63F 13/25

(57) ABSTRACT

Methods, devices, and computing platforms for operating spatially diverse, asynchronous competitions are disclosed. A platform includes a competition control module that determines competition information associated with a competition between spatially distinct competitors, receives video data from devices of each of the spatially distinct competitors, receives a determination of a preferred one of the videos and provides results associated with the competition. In some instances, the computing platform includes an application executing on a mobile device. The application may include a user interface that prompts for and receives back competition information, competition videos, and may display competition results, for instance. In some instances, verification data, such as time, date or location metadata associated with the videos may be encrypted prior to transmission.

This application claims benefit of priority to U.S. Provisional Application No. 62/350,659, filed Jun. 15, 2016, titled “PROFILE-BASED, COMPUTING PLATFORM FOR OPERATING SPATIALLY DIVERSE, ASYNCHRONOUS COMPETITIONS,” each of which is hereby incorporated by reference herein in their entirety

### BACKGROUND

### Technical Field

This disclosure relates generally to a computing platform for competitions, and in particular to improved systems and methods for judging competitions, distributing competition results and/or various use cases.

### Description of the Related Art

Competition, such as competitive athletic events often requires competitors to travel to a common destination to compete. For instance, despite the ability to practice and train at local facilities, roping teams may be called upon to travel to distant locales to compete in rodeos. The travel presents numerous difficulties, such as travel expenses, lack of ability to train while traveling, etc. Additionally, the competition requires that the contestants all travel to the same location for the same duration of time such that the distinct contestants can compete against one-another at the same time, in the same place. This also presents difficulties as some contestants availability may not be the same as others. Sometimes, contestants are forced to choose between competing in two events that happed to be scheduled on the same weekend, thus preventing the contestant from participating in one of the events.

Furthermore, the competitions (e.g., rodeos) are organized by governing bodies that arrange the event to determine a ranking from among a large number of competitors, instead of supporting matches between individuals (e.g., grudge matches).

### SUMMARY OF EMBODIMENTS

Embodiments of the present disclosure describe systems, devices and processes for a profile-based asynchronous, spatially-separated competition and judging system for athletic events. In some embodiments, the system is for distributing prizes for open competitions and challenges. These and other features and advantages will become apparent to those of ordinary skill in the art in view of the following detailed descriptions of the approaches presented herein.

### BRIEF DESCRIPTION OF THE DRAWINGS

FIG. 1 is a high-level diagram illustrating regional sources and movement of data as well as other aspects of a profile-based, asynchronous, spatially-separated competition and judging system for athletic events, according to some embodiments.

FIG. 2 illustrates a profile-based, asynchronous, spatially-separated competition and judging system for athletic events, according to some embodiments.

FIG. 3 is a block diagram of a competition computing platform, according to some embodiments.

FIG. 4 is a flow diagram of a process for profile-based, asynchronous, spatially-separated competition and judging of athletic events, according to some embodiments.

FIGS. 5A, 5B, 5C, 5D and 5E illustrate user interface elements of a competition computing platform, according to some embodiments.

FIG. 6 illustrates year end standings user interface elements of a competition computing platform, according to some embodiments.

FIGS. 7A, 7B, 7C and 7D illustrate user interface elements of a competition computing platform, according to some embodiments.

FIG. 8 illustrates judging user interface elements of a competition computing platform, according to some embodiments.

FIG. 9 is a flow diagram of a process for profile-based, asynchronous, spatially-separated competition and judging of athletic events, according to some embodiments.

FIG. 10 illustrates various elements of a computing system they may be part of the platform or that may provide computing infrastructure support for implementation of various portions of the platform, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g. a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

### DETAILED DESCRIPTION

### Introduction

Various embodiments of a device, system and method for a profile-based, computing platform for operating spatially diverse, asynchronous competitions are described.

Competitions often require contestants from distinct geographical areas to travel to a common destination to compete. For example, roping teams travel to various regional rodeos to compete. In another example, high school track teams travel to neighboring communities to compete with a rival team. Not only do the competitors travel, but the judges and audience also travel to watch the competition. Not only does the requirement to compete at the same location cost time and money for travel, but competitors often are required to compete at the same time or at nearly the same time. For example, roping teams may typically compete one after another in competition so that the audience or judges can compare the performances of the competitors, having the performance of the competitors fresh in their mind due to the timeliness of the various competitors' performances.

A profile-based computing platform for operating spatially diverse, asynchronous competitions can alleviate many of the above-noted deficiencies of prior competitions. For instance, a competition computing platform may act as a recipient of and/or data store for videos of competitor performances. Instead of the competitors traveling, competitors may perform at a more convenient location, make a video of their performance, and rely upon the platform to facilitate execution of the competition.

The platform may receive information about the competition (e.g., rules, competitor information, etc.) as well as the videos from the respective competitor teams and may include program code instructions that facilitate judging of the received videos, sometimes in accordance with the received information about the competition (e.g., the rules, etc.). For instance, the program code of an application of the platform may provide a judging graphic user interface that displays the videos to a judge and receives indications of a winning, or otherwise preferred video or competitor from among the competitors of the competition. The platform may also provide results associated with the competition. For example, the platform may include a software module and data store for storing and instructing display of competition results, or for providing prize money or for automated posting of the results (e.g., of a grudge match) to social media.

In some embodiments, the platform may be configured to perform verification of videos. The verification may be performed via program instructions that use encryption to ensure that metadata associated with the video content accurately measures attributes of the video content, such as the location where, the date and/or time of, or other characteristics associated with video generation. For example, a platform application running on an image capture device or on a data communication device may determine, generate, or otherwise determine metadata associated with captured videos. The platform application may encrypt the metadata prior to transmitting the encrypted metadata to a competition service, sometimes without encrypting other data of the associated video data, such as the content data. In some instances, the platform application may encrypt some portions of the video metadata, but not others. The competitions service may receive the encrypted metadata, decrypt the metadata, and use the decrypted metadata to verify attributes of the associated video content, as part of qualifying for a competition for example.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

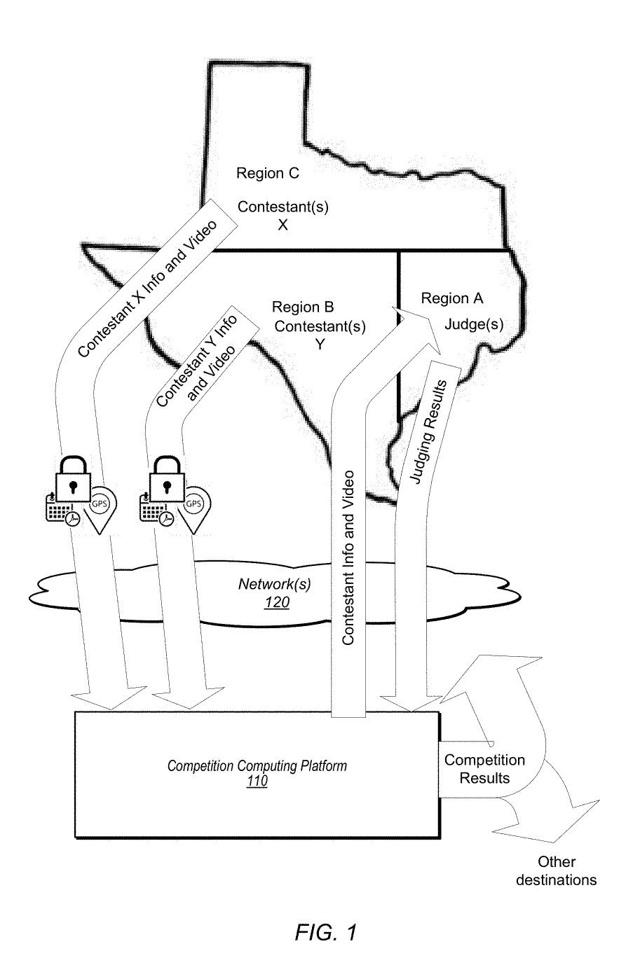

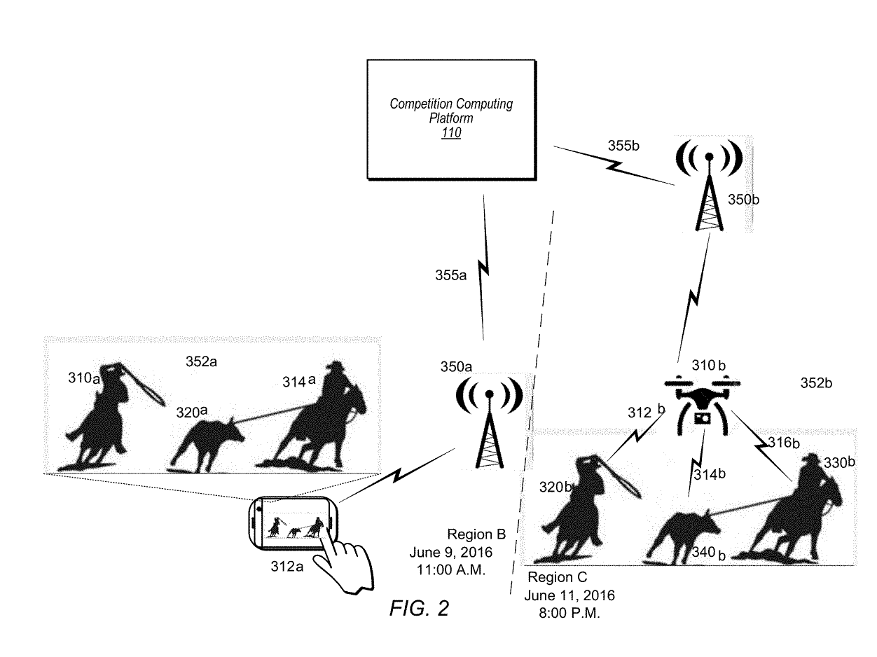

Attention is now directed toward embodiments of a profile-based, computing platform for operating spatially diverse, asynchronous competitions. FIG. 1 is a high-level diagram illustrating regional sources and movement of data as well as other aspects of a profile-based, asynchronous, spatially-separated competition and judging system for athletic events, according to some embodiments. FIG. 1 illustrates data movement that may be carried out via the computing devices and systems and processes illustrated in FIGS. 2-10, in embodiments.

In the illustrated embodiment, an area, Texas for example, may be considered as including various spatially diverse areas. The spatially diverse areas may be rather small, for example, two different baseball diamonds or two different tennis courts at the same facility. The spatially diverse areas may be further apart, such as regions, for example or different countries on a world scale. In some embodiments, the spatially diverse areas may be two physically distinguishable areas, two areas with different GPS coordinates, for example.

FIG. 1 illustrates contestant X information and video being transmitted from contestant X's device in a region C to competition computing platform 110. The figure illustrates the metadata, such as date, time or GPS coordinates may be sent over network(s) 120 in encrypted form. Similarly, transmission of contestant Y information and video is illustrated as being transmitted from a different region B to competition computing platform 110. In some embodiments (not illustrated), competition computing platform 110 may be executing on one of the devices of the competitors and that competitor may receive the video from the other competitor's device at that competitors device, in the other region.

FIG. 1 illustrates that contestant information and video may be transmitted by the competition computing platform 110 to devices of a judge in region A. In some embodiments, the contestant information and/or video may be sent directly from the contestant devices to the judge's devices. Judging results are sent from the judge's device to the competition computing platform, in the illustrated embodiment. In some embodiments, the judging process may be performed via the competition computing platform 110, without sending the video to a separate device of the judging authority. Competition results may be provided (e.g., transmitted over a network) by the competition computing platform 110, to the contestant devices or to other destinations, as illustrated in FIG. 1.

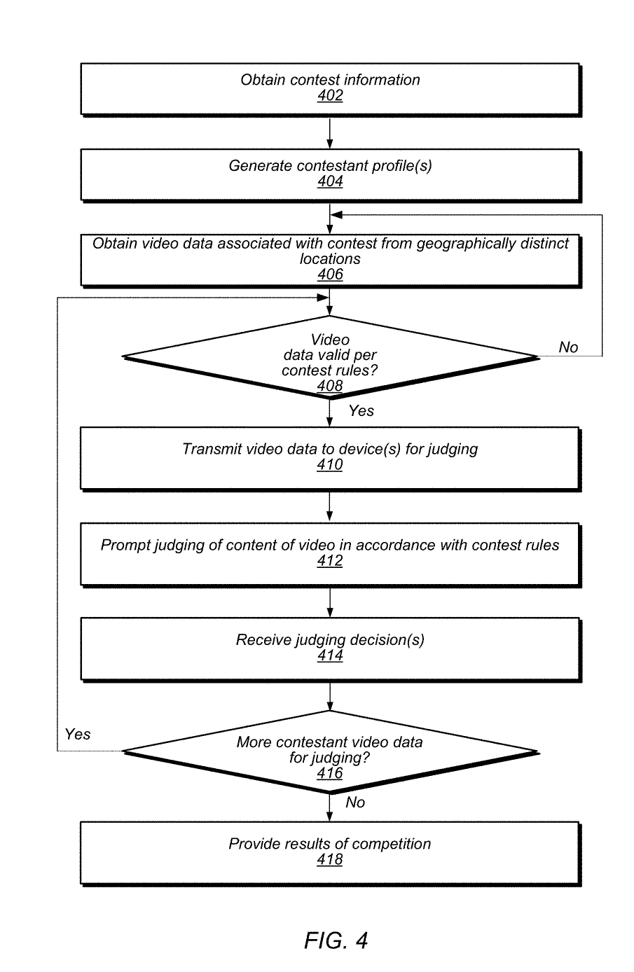

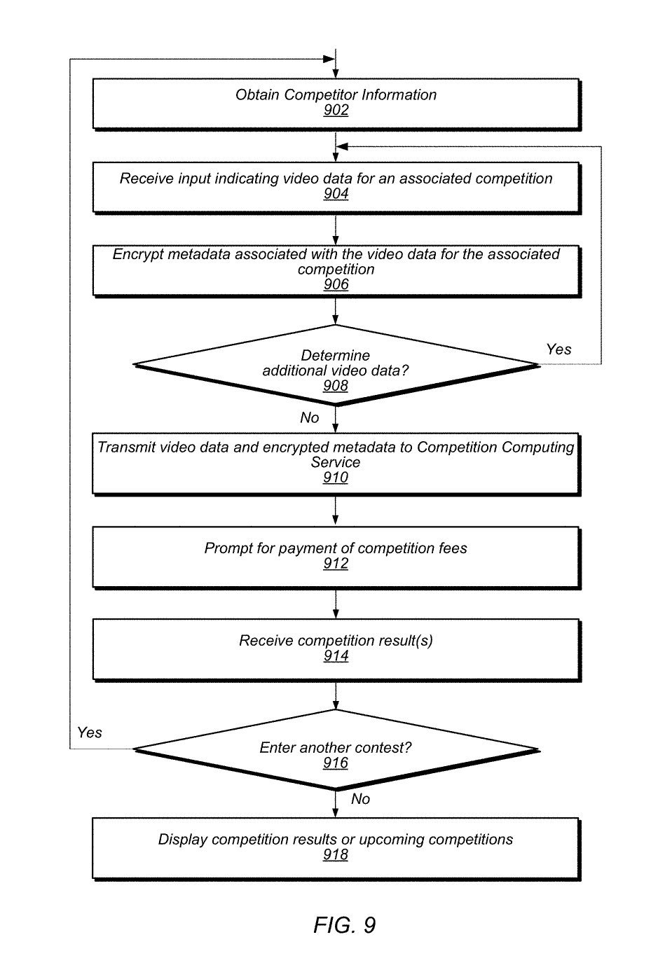

FIG. 2 illustrates a profile-based, asynchronous, spatially-separated competition and judging system for athletic events, according to some embodiments. The illustrated components may perform the processes illustrated in FIGS. 4 and 9, in embodiments. While FIG. 2 illustrates a team roping competition, the platform described herein may be used for operating most any other competition, such as, but not limited to other rodeo events, sports competitions, grudge matches, etc. In the illustration, two different teams each perform their part of the competition on two different days and at two different times and at two different locations. As described herein, the competition computing platform receives data from the devices of the teams, and operates the asynchronous, spatially diverse competition, in embodiments.

In the illustrated embodiment, header/healer team 352a in Region A is illustrated as performing a team roping exercise including calf on Jun. 9, 2016 at 11:00 A.M. Device 312a (e.g. a smartphone) is illustrated as capturing the event as a video and transmitting the captured video to the competition computing platform 110 via networks 355a and transmission tower 350a.

FIG. 2 also illustrates team 352b with follow-me devices (e.g., GPS units) 320b, 330ba and the calf is illustrated with a follow-me unit 340b, as well. Team 352b is illustrated as performing their part of the competition in Region C on Jun. 11, 2016 at 8:00 P.M. The device 310b is illustrated capturing video data of the performance. In embodiments, video data may include metadata about the video data that is associated with the video by the transmission device that transmits the video from the distinct spatial location (e.g., an iPhone app may add a geo stamp to video from the drone). In some embodiments, the signals from the follow-me devices are used by an application running on the device 310b (e.g., a drone). For example, data transmitted from the follow-me devices to the device 310 may be used by software executing on the drone or on a device controlling the drone (e.g., a smartphone, not illustrated) to follow the action of the team and to instruct the drone to a preferred position for capturing the action. FIG. 2 illustrates that data (e.g., video data, associated metadata, competitor information) associated with team 352Bs performance is transmitted to competition computing platform 110 via network 35b and tower 350b.

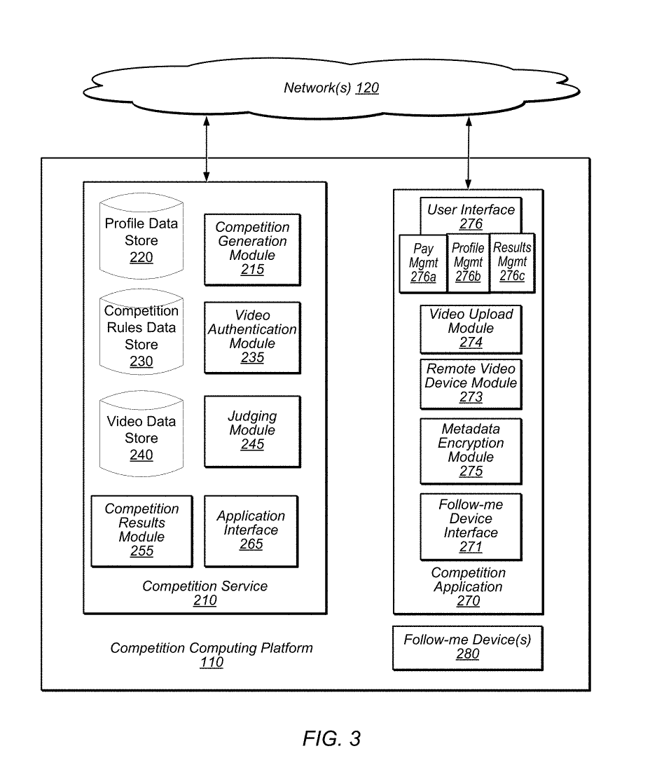

FIG. 3 is a block diagram of a competition computing platform, according to some embodiments. FIG. 3 illustrates a platform 110 that includes a competition service 210, competition application 270, and follow-me devices 280. Various embodiments of the platform may include all or some of these features. In one embodiment, the competition service 210 executes on a cloud computing service, the competition application 270 executes on a smartphone or other image capture device and the follow-me devices 280 are worn by entities participating in the competition. The various modules and functionality associated with those modules may be arranged other than illustrated, in some embodiments. For instance, the competition service 210 may execute on one of the smartphones of the competitors, in some embodiments. Embodiments with additional or fewer components are contemplated. Various of the components may communicate with one another via network(s) 120.

Various data stores are depicted. Profile data store 220 stores competitor profile information. Competition rules data store 230 stores rules associated with competitions. In some embodiments, the competitors may be presented with text-based rule options from the data store. The competition generation module 215 may generate display pages or prompts for the judging console based at least in part on the text-based rule options selected by the competitors, in embodiments. The video data store 240 may store the videos that are received from competitors. The video authentication module 235 may perform validation and/or verification of the videos, verifying that metadata associated with the videos matches rules of the competition, for instance.

Judging module 245 may be configured to generate a judging console, and transmit the console, as well as the videos to a device associated with the judging entity. The judging module 245 may be configured to prompt the judging entity for responses and to provide the received responses back to the competition service. The responses may be stored in a data store, in embodiments.

Application interface 265 may be configured to interface with competition application 270. For instance, application interface 265 may include an API for applications to interface with the competition service.

Competition application 270 is depicted with user interface 276, which may include program instructions, logic and user interface elements (e.g., user interface elements and logic for electronic pay management 276a, profile management 276a, and/or results management 276c). Video upload module 274 may be configured to provide user interface elements and logic associated with uploading competitor's videos to the competition service. In some embodiments, this module may add time stamp and gps coordinates to video (e.g., video captured and transmitted from a drone to a smartphone executing the application). In some embodiments, the video upload module may add gps metadata received from gps trackers to the video data (e.g., gps trackers on horses, steers, contestants or contestant equipment may provide location information to the video upload module).

Metadata encryption module 275 may encrypt at least some of the metadata associated with the video or video data. For instance, the metadata encryption module 275 may coordinate with the video upload module to encrypt at least some portion of the video metadata prior to transmission of the video data.

In some embodiments, the competition application may include a follow-me device interface. For instance, drone devices sometimes include a follow-me feature where the person who is to be filmed carries a gps-enabled device such that the drone tracks the GPS-enabled device, attempts to follow the GPS-enabled device, and attempts to direct the drone camera in the direction of the person wearing the GPS-enabled device. As described herein, contestants, and facilities of the contest (e.g., steers, horses, jet skis, snowmobiles, dirt bikes, etc.) may be fitted with a GPS-enabled device. The follow-me device interface 271 may be configured to receive data from one or more follow-me devices and to adjust its' flight path and/or camera direction based on the received data.

In some embodiments, the follow-me device interface 271 may include program logic that, based upon location information from a plurality of follow-me devices, determines a flight path or camera angle for best capturing the greatest number of entities fitted with the corresponding follow-me devices.

FIG. 4 is a flow diagram of a process for profile-based, asynchronous, spatially-separated competition and judging of athletic events, according to some embodiments.

The illustrated process may be performed by various components of the competition computing platform 110, such as by competition service 210 for example. Some of the steps of the process may be performed by competition application 270, in embodiments.

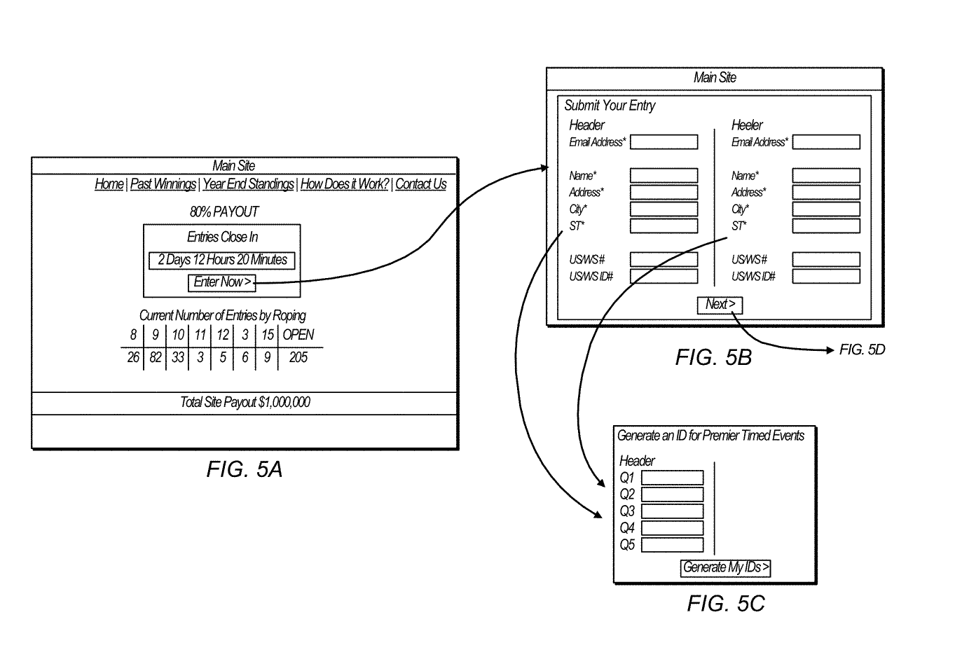

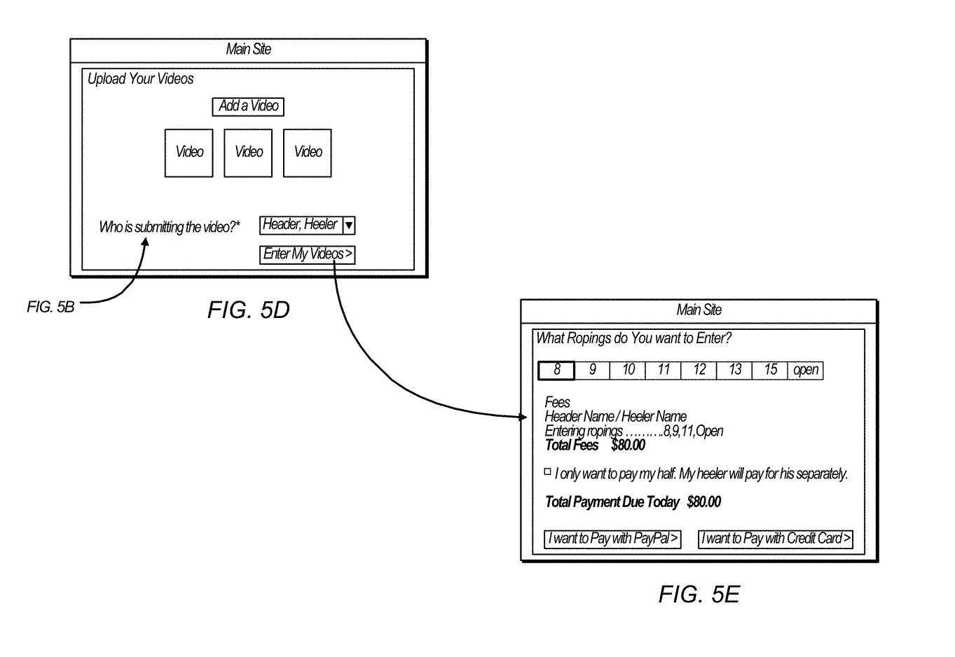

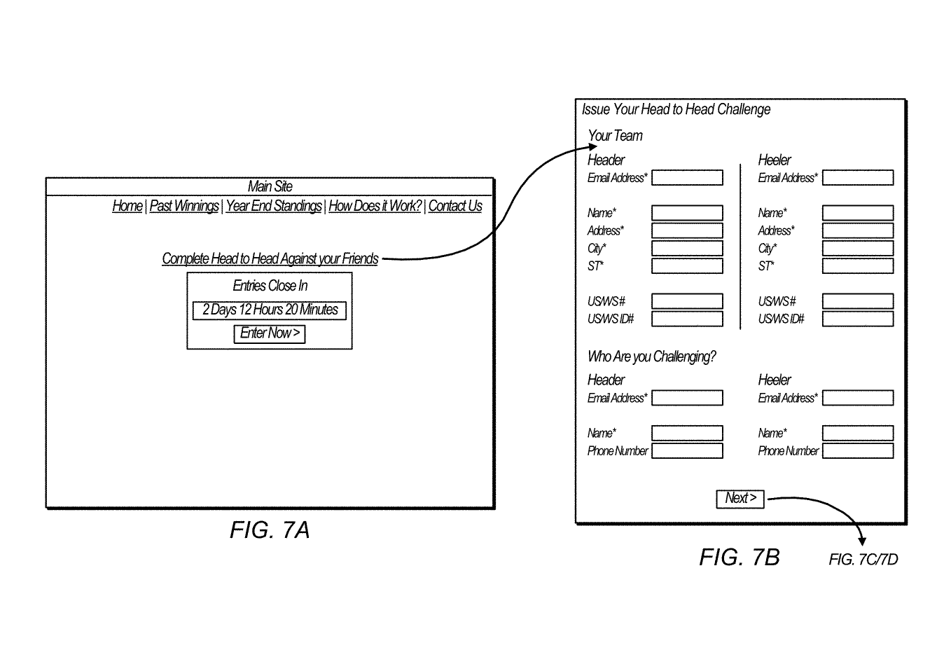

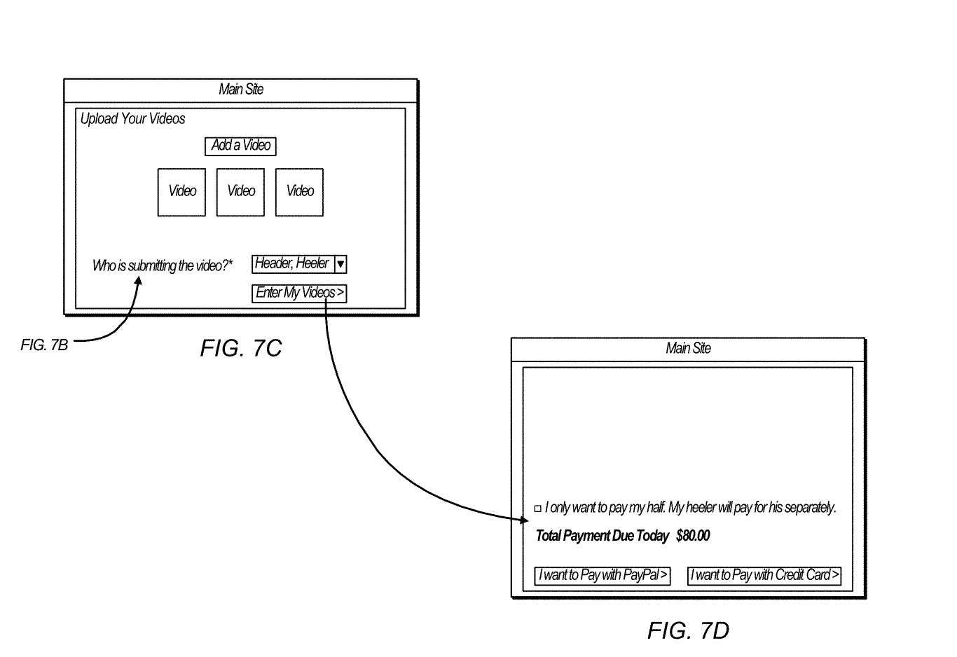

Contest information is obtained (block 402). For example, competition application 270 may include user interface elements configured to prompt competitors to enter information (non-limiting examples provided in FIGS. 5A-5E and 7A-7E). In some embodiments the contest information may include information about the type of competition, for example, whether it is an open or public competition or a closed competition such as a grudge match. Other contest information may include rules of the competition, geographic or schedule restrictions, performance locations and so on. Competition information may also include prizes, payouts, rankings, or other information associated with the outcome of the contest, for example. In embodiments, the distinct spatial areas may be defined in the obtained competition information, and may be enforced (e.g., at block 408).

Contestant profile(s) are generated (block 404). For instance, a profile for each contestant may be generated based on the obtained contest information or based on other user interface elements used to obtain contestant profile information.

Block 406 illustrates that video data associated with the contest is obtained from geographically distinct areas. For instance, as illustrated in FIGS. 1 and 2, video data may be received by components of the competition computing platform from distinct regions B and C. In some embodiments, user interface elements of a platform application 270 may prompt a competitor to upload video. In another embodiment, the competitor may send the video via e-mail to the competition service. At block 408, the video data may be validated based in accordance with contest rules, for example. In some instances, the video authentication module 235 may be configured to obtain metadata associated with the videos and verify (e.g., verify based upon any combination of video metadata such as characteristics of the video generation device, video generation date or time, location of the device at the time of video creation, etc.).

If the video is invalid (block 408, no), the process may return to block 406. For instance, the application may prompt the competitor for another video. If the video is valid, the video data may be transmitted to a device for judging (block 410). For instance, judging module 245 may instruct transmission of the validated competition videos to a device of a judge for a decision, as illustrated in FIG. 1.

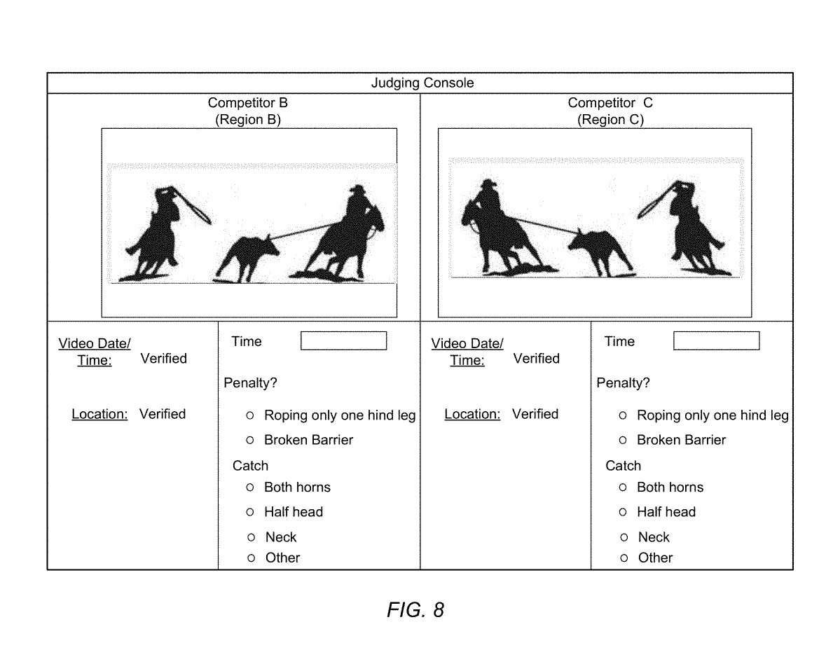

The judging of the content of the video in accordance with contest rules may be prompted (block 412). For example, user interface elements may be transmitted to a device of the judging entity that instruct the judging entity to select the video of the contestant that performed the best according to the contest rules (e.g., FIG. 8). In some instances, the judging may be performed via components of the competition service without transmitting the video content to another device.

The judging decision is received (block 414). For instance, the judging may receive instructions indicating the preferred video or contestant and store the result in a data store. In another example, the received judging decision may be scoring results associated with a competitor's video. If additional contestant videos are available for judging, the system may return to block 408 and repeat the process for additional videos (block 416). Otherwise, the platform may provide results of the competition. For example, the competition results module 255 may generate user interface elements describing the results of the competition or may instruct payout of the winning prize money.

FIGS. 5A, 5B, 5C, 5D and 5E illustrate user interface elements of a competition computing platform, according to some embodiments. FIG. 5A illustrates the landing page for an open competition with an 80% payout (rules of the competition). Selection of the “Enter Now” user interface element cause the system to transition to the entry information form illustrated in FIG. 5B.

In some embodiments, the system may use data from the entry information form to generate an ID particular to the competition platform or unique to the type of sport, for example. FIG. 5C illustrates a number of questions that prompt the competitor to enter information that is used to generate an id. Selection of the “Next” button illustrated in FIG. 5B causes the system to transition to the page illustrated in FIG. 5D, where the system generates and displays prompts for the competitor to identify videos for upload to the competition service 210. FIG. 7D illustrates a payment page for entering payment information.

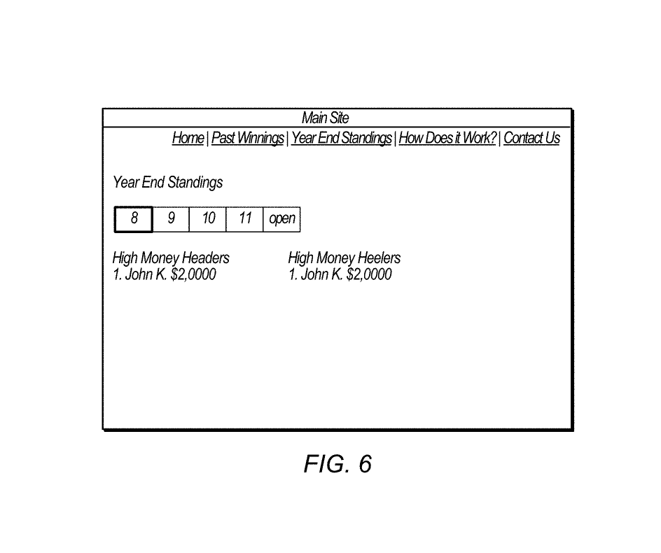

FIG. 6 illustrates year end standings user interface elements of a competition computing platform, according to some embodiments. FIG. 6 illustrates a year end standings page.

FIGS. 7A, 7B, 7C/7D and 7E illustrate user interface elements of a competition computing platform, according to some embodiments. FIG. 7A illustrates a landing page that describes a grudge match competition. As depicted, selection of a user interface element from the landing page causes the system to display a page (FIG. 7B) that prompts competitors for team information. As depicted, selection of the “Next” user interface causes the system to display the user interface depicted in FIG. 7C that prompts the competitor to upload the videos of the competitor. Selection of the “Enter My Videos” button causes the system to transition to the page illustrated in FIG. 7D where a betting amount is entered and other options selected (e.g., payment options).

FIG. 8 illustrates judging user interface elements of a competition computing platform, according to some embodiments. In embodiments, the judging user interface may be implemented by a combination of the judging module and the competition rules data store. For instance, rules of the competition obtained during step 402 or otherwise may be turned into user interface elements of a judging console illustrated in FIG. 8. In the illustrated embodiment, a judging console for judging grudge matches is depicted.

Video content from competitor B is depicted on the left and video content from competitor C is depicted in the right. In embodiments, various video controls may be provided (not illustrated). The judging console is depicted with metadata associated with the videos (e.g., video date/time and location information for where the video was generated). The judging console is also depicted with interface elements that a judge interacts with for scoring the videos. For instance, the illustrated embodiment depicts a time entry box, where the judge enters a time associated with performance of the roping of the steer. Other user interface elements prompt the judge for penalties and descriptors of the catch that may be associated with points. Such user interface elements may be generated based on rules from a rules data store, for instance. In some embodiments, the videos themselves may be selectable such that selection of the video indicates a preferred video or a winner of the grudge match. An indication of the selection may be transmitted to the competition service 210, in embodiments.

FIG. 9 is a flow diagram of a process for profile-based, asynchronous, spatially-separated competition and judging of athletic events, according to some embodiments. In the depicted process, some or all of the metadata associated with a video is encrypted, to deter tampering for example. At least some of the steps of the process may be carried out by an application executing on a mobile device such as a smartphone or some image capture device, such as a drone, for example.

At block 902, competitor information is obtained. For example, the application may prompt the competitor to enter competitor information (as simple as user name password/login to existing account or start from beginning). At 904, input indicating video data for an associated competition is received. For instance, the application may prompt the competitor to enter the location of an existing video or the application may prompt the competitor to begin filming the contestant performing. At block 906, data associated with the video data from the associated competition is encrypted. For instance, at least time and date metadata and/or location information (e.g., GPS coordinates) may be encrypted. In some embodiments, only some of the metadata is encrypted. Geotagging creates geocoded pictures, in some embodiments.

At block 908 the application may determine whether additional video data is to be collected (the contest rules may provide for three tries of the performance, for example). If so, the process may return to block 904. Otherwise, video data and encrypted metadata may be transmitted to the competition computing service (block 910). Payment of competition fees or wagers may be prompted (block 912). Additional information may be prompted. For instance, the application may prompt for particular ropings to enter at this point too. At block 914, competition results are received, from the competition service 110, for example. At block 916, a prompt for entering another contest may be transmitted or displayed. If yes, the process may return to block 902. Otherwise, the process may display competition results or upcoming competitions (block 918).

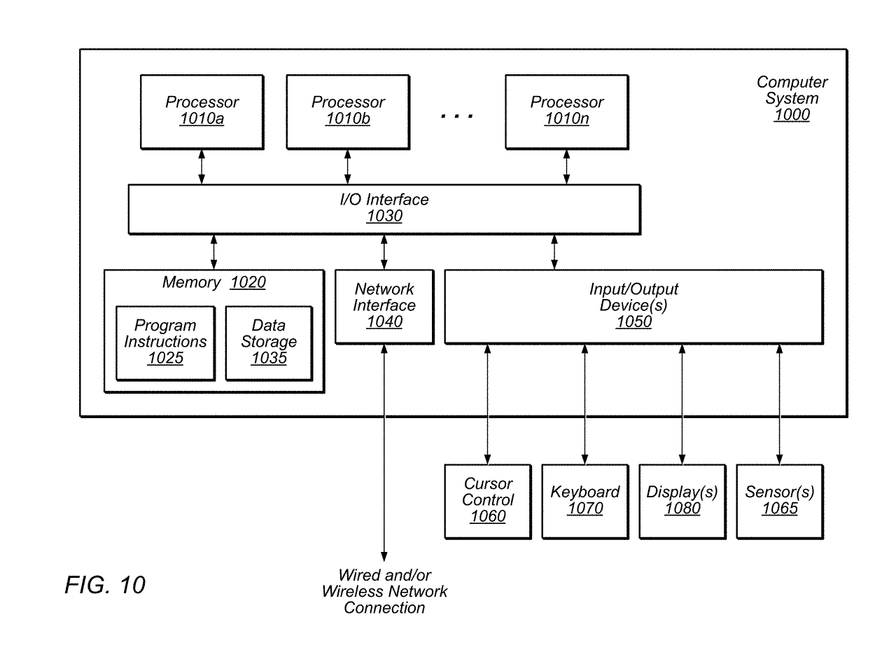

FIG. 10 illustrates various elements of a computing system they may be part of the platform or that may provide computing infrastructure support for implementation of various portions of the platform, according to some embodiments. FIG. 10 illustrates a computer system 1000 that is or may be configured to execute any or all of the embodiments described above. In different embodiments, computer system 1000 may be any of various types of devices, including, but not limited to, a server (e.g., a cloud computing server or web server, a personal computer system, desktop computer, laptop, notebook, tablet, slate, or netbook computer, mainframe computer system, handheld computer, workstation, network computer, a camera, a video-enabled watch, a set top box, a mobile device, a consumer device, video game console, handheld video game device, application server, content server, storage device, a television, a video recording device, a peripheral device such as a switch, modem, router, or in general any type of computing or electronic device.

Various embodiments of a profile-based computing platform for operating spatially diverse, asynchronous competitions, as described herein, may be executed on one or more computer systems 1000, which may interact with various other devices, which themselves may be computer systems similar to the one illustrated in FIG. 10. Note that any component, action, or functionality described above with respect to FIGS. 1-9 may be implemented on one or more computers configured as computer system 1000 of FIG. 10, according to various embodiments. In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, display(s) 1080, sensor(s) 1065 (e.g., motion and/or image sensor(s)). In some cases, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g. two, four, eight, or another suitable number). Processors 1010 may be any suitable processor capable of executing instructions. For example, in various embodiments processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

System memory 1020 may be configured to store program instructions 1025 and/or data 1035 accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions 1025 may be configured to implement a contextual video content adaptation application incorporating any of the functionality described above. Additionally, data storage 1035 of memory 1020 may include video content and video metadata, including any of the information or data structures described above, including but not limited to video images or frames and corresponding metadata used in implementing the techniques described herein. In some embodiments, program instructions and/or data may be received, sent or stored upon different types of computer-accessible media or on similar media separate from system memory 1020 or computer system 1000. While computer system 1000 is described as implementing the functionality of functional blocks of previous figures, any of the functionality described herein may be implemented via such a computer system.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g. system memory 1020) into a format suitable for use by another component (e.g. processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network (e.g. carrier or agent devices) or between nodes of computer system 1000. The network(s) may in various embodiments include one or more networks including but not limited to Local Area Networks (LANs) (e.g. an Ethernet or corporate network), Wide Area Networks (WANs) (e.g. the Internet), wireless data networks, cellular networks, some other electronic data network, or some combination thereof. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or accessing data by one or more computer systems 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 10, memory 1020 may include program instructions 1025, which may be processor-executable to implement any element or action described above. In one embodiment, the program instructions may implement the methods described above, such as the methods illustrated by FIGS. 4 and 9. In other embodiments, different elements and data may be included. Note that data 1035 may include any data or information described above.

Those skilled in the art will appreciate that computer system 1000 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g. as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g. disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of embodiments as defined in the claims that follow.

1. A system comprising a computing platform for operating competitions, the computing platform for operating competitions comprising:
one or more processors; and
memory storing program instructions that are executed by the one or more processors to implement a competition control module configured to:
obtain competition information associated with a competition between each of a plurality of entities, respective portions of the competition to be performed in distinct spatial areas from one another;
receive video data from respective video devices of each of the plurality of competing entities, each of the video data including video content of the respective entity competing in the competition, the respective video data received from respective video devices that obtained the respective video data from distinct spatial areas;
verify, from metadata associated with the video data content, whether the video data is valid in accordance to at least one rule of the competition;
receive a determination of a preferred one of the plurality of videos that are valid; and
provide to a computing system, based at least in part on the received determination, results associated with the competition.

2. The computing system recited in claim 1, further comprising program instructions that are executed by one or more processors to implement a video data authentication module configured to:
extract metadata from respective ones of the received video data;
determine, based at least in part on the extracted metadata and the obtained competition data associated with the competition, whether the respective received video data was generated within a valid competition time period defined by the obtained competition data;
mark video data that is determined to have been generated within the valid competition time period as valid; and
mark video data that is determined to have been generated outside the valid competition time period as invalid.

3. The system of claim 1, wherein the obtained competition information includes:
an indication of a valid period of time for competing in the competition; and
a respective indication, for each of the plurality of entities, of a spatially distinct area where respective entities are to compete; and
wherein the program instructions cause the one or more processors to determine whether each of the respective videos is valid, said validity determined based at least in part on:
a comparison of the respective indication of the spatially distinct area associated with the respective entity to location information metadata from the respective video data; and
a comparison of the valid period of time for competing in the competition to date information from the respective video data.

4. The system of claim 1, wherein the program instructions are further executed to
transmit the video data to a plurality of computing devices of a viewing audience;
receive respective indications of a preferred video data from each of the plurality of devices of the viewing audience;
tally the indications; and
determine the preferred one of the plurality of videos based at least in part on the tally of the indications of the preferred video data from each of the plurality of devices of the viewing audience.

5. The system of claim 1, further comprising:
program instructions that are executed by one or more processors on a given one of the competitor's video devices to implement a competition video application configured to:
generate, prior to transmission of the respective video data to the competition control module, an association between the respective video data and a competitor identifier that distinctly identifies the competitor from other competitors in the competition; and
transmit the association to the competition control module.

6. The system of claim 1, further comprising:
program instructions that are executed by one or more processors on a given one of the competitor's video devices to implement a competition video application configured to:
receive coordinates of a plurality of follow-me devices; and
transmit instructions causing a controllable image capture device to coordinate movement of the controllable image capture device based at least in part on the received coordinates.

7. The system as recited in claim 5, wherein the controllable image capture device includes a camera-enabled drone device.

8. A method, comprising:
performing by one or more computers comprising one or more hardware processors and memory:
determining competition information associated with a competition between each of a plurality of entities, respective portions of the competition to be performed in distinct spatial areas from one another;
receiving video from each of distinct video devices of each of the plurality of competing entities, each of the respective videos including video content of the respective entity competing in the competition, the respective videos received from respective video devices that obtained the respective video data at distinct spatial areas;
verifying, from metadata associated with the video content, whether the video is valid in accordance to at least one rule within the competition information;
receiving a determination of a preferred one of the plurality of videos that are valid, the determination based at least in part on the competition information; and
providing to a computing system, based at least in part on the received determination, results associated with the competition

9. The method of claim 8, wherein said receiving video from each of distinct video devices includes receiving at least one of the videos on a different day from at least another one of the videos.

10. The method of claim 8, wherein the competition information describes a head-to-head competition between two entities.

11. The method of claim 10, wherein said providing results associated with the competition includes transmitting instructions to a digital social media web-site that instruct posting of the competition results.

12. The method of claim 11, wherein said providing results associated with the competition includes transmitting instructions causing transfer of funds to a financial account associated with the competing entity of the preferred video.

13. The method of claim 8, further comprising prior to said receiving the determination of the preferred one of the plurality of videos, transmitting each of the competing videos to a device associated with a judging entity along with instructions instructing selection of a preferred one of the videos, the instructions based at least in part on the determined competition information.

14. The method of claim 13, wherein the instructions instructing selection of the preferred one of the videos include instructions instructing selection of the preferred one of the videos based at least in part on determining a time or score associated with the content of each respective video.

15. The method of claim 8, further comprising:
determining a ranking, based at least in part on a computer-based ranking process, one or more of the plurality of entities; and
instructing display of the ranking via graphical user interface elements.

16. A non-transitory computer-readable medium storing program instructions that are executable by one or more processors to:
receive input indicating video data for an associated competition;
transmit video data and associated metadata to a competition computing service;
verify based on the associated metadata and at least one rule of the associated competition whether the video is valid or invalid;
transmit, to a device for judging, the video when the video is valid; and
receive results of the competition, the results based at least in part on the video data and the associated metadata,
wherein the results of the competition are determined based upon video data from respective competitor devices of a plurality of competitors, capture of respective video data in distinct geographical locations.

17. The non-transitory computer-readable medium of claim 16, wherein the program instructions are further executable by the one or more processors to encrypt the metadata associated with the indicated video data for the associated competition, the transmitted metadata is the encrypted metadata.

18. The non-transitory computer-readable medium of claim 17, wherein the encrypted metadata includes a date associated with generation of the indicated video data.

19. The non-transitory computer-readable medium of claim 16, wherein the program instructions are further executable by the one or more processors to:
obtain coordinates associated with the location of the generation of the indicated video data; and
transmit the coordinates to the competition computing service.

20. The non-transitory computer-readable medium of claim 19, wherein the coordinates are encrypted prior to said transmit.
